(19) United States
(12) Patent Application Publication
(10) Pub. No.: US 2004/0085225 A1
(43) Pub. Date: May 6, 2004

(54) Methods and apparatus to monitor the inventory of a food storage unit

(76) Inventor: Alison D. Wilson, Woodridge, IL (US)

Correspondence Address: GROSSMAN & FLIGHT LLC, Suite 4220, 20 North Wacker Drive, Chicago, IL, 60606-6357, US

(21) Appl. No.: 10/697,675

(22) Filed: Oct. 29, 2003

Related U.S. Application Data
(60) Provisional application No. 60/423,909, filed on Nov. 5, 2002.

(51) Int. Cl. G08B 21/00; G08C 19/12; G08C 19/16

(52) U.S. Cl. 340/870.16; 340/870.17

(57) ABSTRACT

Methods and apparatus to monitor the inventory of a food storage unit are disclosed. According to one example, an apparatus to represent the contents of a food storage device includes a housing and an informational area associated with the housing, wherein the informational area includes a number of fields in which information related to food items in the food storage device may be recorded. The apparatus may also include a food storage guideline informational item associated with the housing and representing time durations for which particular food items may be stored without spoiling.

### RELATED APPLICATION

This application claims the benefit of U.S. Provisional Application Serial No. 60/423,909, filed Nov. 5, 2002.

### TECHNICAL FIELD

The present disclosure pertains to food management and, more particularly, to methods and apparatus to monitor the inventory of a food storage unit.

### BACKGROUND

Today, people's lives are busier than ever. Parents frequently pass one another in the driveway as they take children to events such as swimming, soccer, dance, etc. Similarly, working couples may have hectic work schedules. As people's lives become complicated with a number of obligations, food may be prepared in advance, taken as carryout, or stored as leftovers. In general, consumers tend not to know what food has been stored in their refrigerator and/or freezer and, once the identity of the food is determined, how long that food has been stored or for how long the food is edible. For example, a leftover piece of pizza may be wrapped in foil and placed in a refrigerator by a first person and thereafter completely forgotten. A second person, upon opening the refrigerator, may not take the time to unwrap the unidentified foil object and may seek food from another source, thereby leaving the pizza uneaten until it is later discovered. Alternatively, the second person may discover the pizza and refuse to eat it based on not knowing how long it has been stored or for how long it is edible.

The foregoing food storage problem of not easily identifying food items and/or letting food items spoil due to edibility concerns is exacerbated in situations involving multiple, independent consumers that share a common food storage area (e.g., a refrigerator and/or freezer). For example, in a college apartment with five roommates, roommates may forget what they have placed in storage and/or may not know whose food is whose. This confusion often leads to eating of another person's food items and/or the spoilage of food items due to forgetfulness as to what a particular person placed in storage at what point in time.

In addition to all of the foregoing,, there is large degree of uncertainty regarding how long food will keep under various conditions. For example, consumers are generally unaware of how long meat will keep in a refrigerator, as opposed to how long the meat will keep in a freezer. Even though the United States Department of Agriculture (USDA) has published guidelines for food storage durations and locations, the guidelines are almost never handy, even assuming a consumer somehow knew when food items were placed in storage.

### BRIEF DESCRIPTION OF THE DRAWINGS

FIG. 1 is an example diagram of a first food storage monitoring system.

FIG. 2 is an example informational item that is a chart of food cold storage guidelines.

FIG. 2A is an example informational item that is a chart of wine storage guidelines.

FIG. 3 is an example rear view of the system of FIG. 1.

FIG. 4 is an example diagram of a second food storage monitoring system.

FIG. 5 is a block diagram representing one example of the basic components of the system of FIG. 4.

FIG. 6 is a flow diagram representing example operation of the system of FIGS. 4 and 5.

FIG. 7 is an illustration of an example food storage unit having either the first or second systems disposed thereon.

### DETAILED DESCRIPTION

Although the following discloses examples including, among other components, software executed on hardware, it should be noted that such systems are merely illustrative and should not be considered as limiting. For example, it is contemplated that any or all of these hardware and software components could be embodied exclusively in dedicated hardware, exclusively in software, exclusively in firmware or in some combination of hardware, firmware, and/or software. Accordingly, while the following describes examples, persons of ordinary skill in the art will readily appreciate that the examples are not the only way to implement such systems.

As described below, the disclosed systems provide consumers with an easy way to keep track of stored food items. In one example, the product is clearly visible each time the food storage unit (e.g., a refrigerator and/or freezer and/or cabinet) is approached. The following describes two different example implementations of the system, one being largely manual or mechanical and the other being electronic in nature. However, those having ordinary skill in the art will readily recognize that manual and electronic examples disclosed herein may be modified in any number of different ways. For example, portions of the manual system may be implemented in the electronic system and vice versa. The disclosed systems are useful for tracking leftovers, carryout items, or any other food to be stored. The systems are also useful for those consumers who cook in large quantities, to create leftovers purposefully.

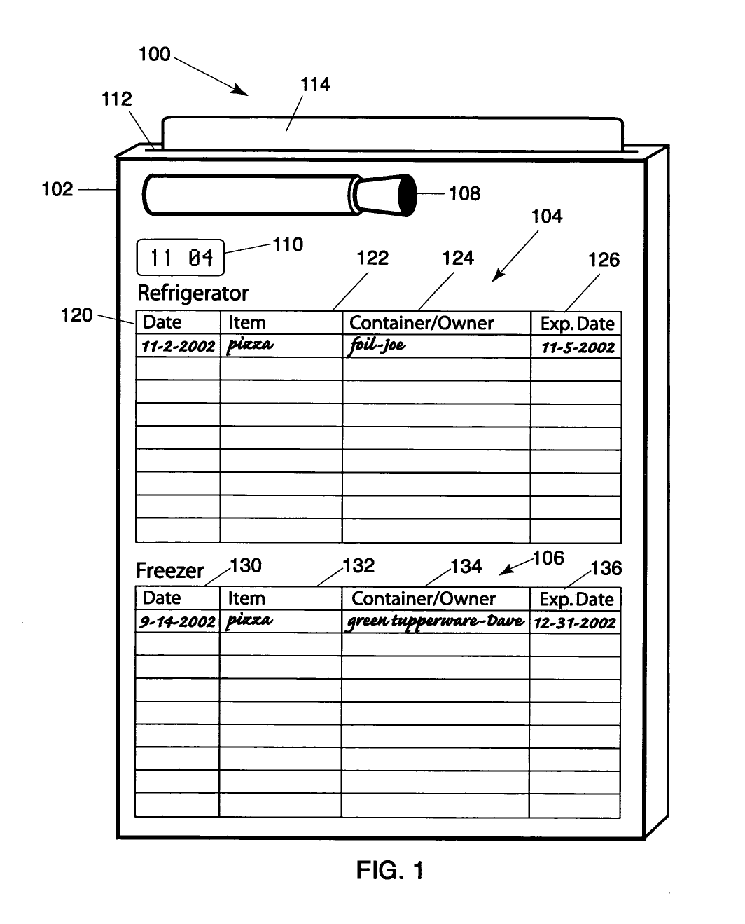

As shown in FIG. 1, a first example food storage monitoring system 100 (hereinafter “the first example system 100”) generally includes a housing 102 having first and second portions 104, 106 in which information related to contents of food storage devices may be written. Further, the first example system 100 may include a writing device 108 that is removably attached to the housing 102 and may further include a temporal information display 110.

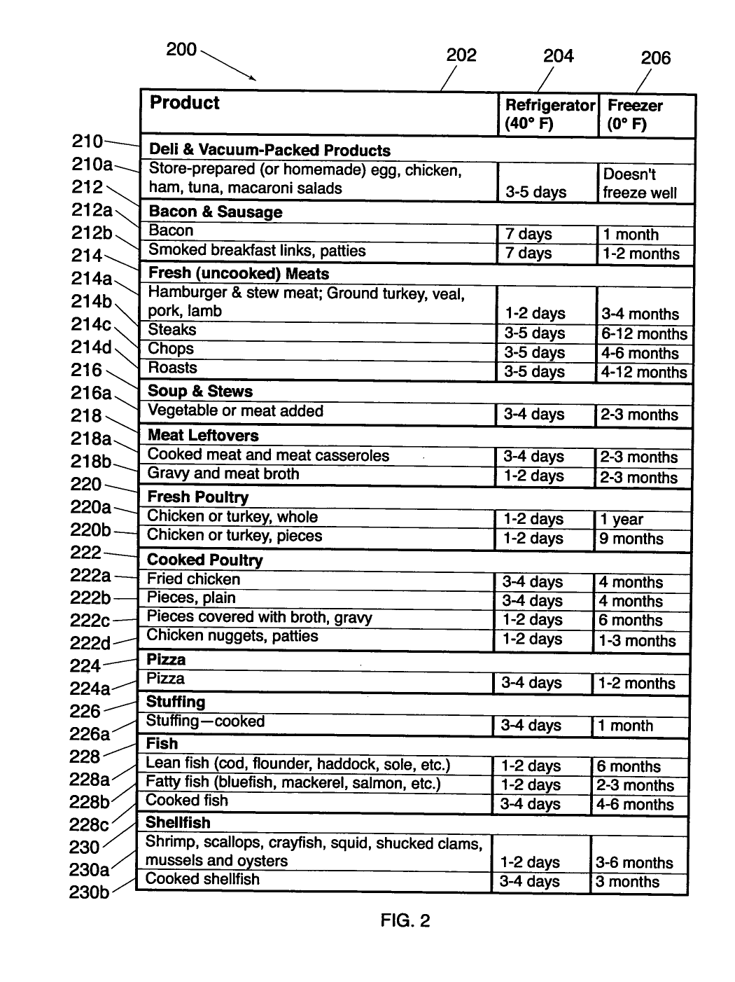

In one example, the housing 102 may be fabricated from a unitary piece of molded plastic or may be fabricated from a number of molded plastic pieces that are fastened together with screws, glue, etc. In the alternative, the housing may be fabricated from any other material than molded plastic (e.g., fiberglass, resins, metal, etc.). The housing 102 may include a slot 112 into which an informational item 114 may be inserted. As described below in conjunction with FIG. 2, the informational item 114 may be a paper, plastic, or other suitable implementation of cold food storage guidelines.

As shown in FIG. 1, the first portion 104 may correspond to refrigerator contents. In particular, the first portion 104 may include various fields into which information regarding food items may be placed. For example, as shown in FIG. 1, the first portion 104 may include date 120, item 122, container/owner 124, and expiration date 126 fields. Of course, the fields 120, 122, 124, and 126 are not the only fields that may be implemented on the first portion 104. Any desired additional fields may be added to the first portion 104. Additionally, the fields of the first portion 104 may be subdivided. For example, the field 124 may be divided into to separate fields, one for container, and one for owner. The first portion 104 may be fabricated as a dry erase board, a chalkboard, paper, or any other material onto which information pertinent to food items in a refrigerator may be written.

The second portion 106 may correspond to freezer contents. Like the first portion 104, the second portion 106 may include date 130, item 132, container/owner 134, and expiration date 136 fields. As will be readily appreciated, more or fewer fields may be used in the second portion 106. As with the first portion 104, the second portion 106 may be fabricated as a dry erase board, a chalkboard, paper, or any other material onto which information pertinent to food items in a freezer may be written.

While first and second portions 104, 106 are shown in FIG. 1, those having ordinary skill in the art will readily appreciate that the first and second portions 104, 106 could be combined into a single portion into which information pertinent to food stored in a refrigerator and/or freezer may be recorded. In an arrangement including a single portion, an additional data field could be included for users to designate whether the information is pertinent to foods stored in a refrigerator or a freezer.

The writing device 108 may be removeably mounted to the housing 102 using, for example, a clip, Velcro pads, adhesive, magnets, etc. Additionally, the writing device 108 may be tethered to the housing through the use of a thread, a string, a wire, or any other suitable device. In practice, the writing device 108 may be implemented using a dry erase marker, chalk, a pencil, a marker, or any other suitable writing device. The implementation of the writing device 108 may be selected to match the medium used to implement the first and second portions 104, 106. For example, if the first and second portions 104, 106 are implemented using a dry erase board, the writing device 108 may be implemented using a dry erase marker.

The temporal information display 110 may be any device showing time-based information such as time and/or date. In implementation the temporal information display 110 may be a liquid crystal display (LCD), a light-emitting diode (LED) display, an analog display, or any other display technology. In one particular example, which is shown in FIG. 1, the temporal information display 110 may be an LCD display that shows the number of the month (e.g., 11 represents November) and the number of the day (e.g., 04 represents the fourth day of the month). In another alternative, the temporal information display 110 may be an area of paper, dry erase board, or the like in which users could write the present date. As a further alternative, the temporal information display 110 may be a monthly or weekly calendar from which users may obtain the present date. Although shown in the example of FIG. 1, in another example the temporal information display 110 could be eliminated from the housing 102, which would require users to obtain temporal information (e.g., date and/or time information) though an alternate source such as, for example, a wristwatch, a calendar, etc.

The slot 112 in the housing 102 may be formed as an opening cut in the housing 102 or, alternatively, may be formed between two halves of the housing 102. The slot 112 is sized to accommodate the informational item 114. The depth of the slot 112 may be such that the informational item 114 extends above an upper surface of the housing 102 when the informational item 114 is inserted into the slot 112. In contrast to the slot location shown in FIG. 1, the slot 112 could be made in the side of the housing 102 so that the informational item 114 could be inserted horizontally into the housing 102. In general, as described below in detail in conjunction with FIG. 2, the informational item 114 may be a plastic card, a laminated sheet of paper, etc. on which food storage guidelines may be printed.

Referring to FIG. 2, an example informational item 200 that may be used to implement the informational item 114 of FIG. 1 includes a product column 202 listing products in question and further includes refrigerator and freezer columns 204, 206 that provide time durations for which items listed in the product column 202 are viable. In general, the example informational item 200 provides a listing of foods and how long they may be stored in either a refrigerator or a freezer. The product column 202 may be segmented into a number of categories, shown generally at reference numbers 210, 212, 214, 216, 218, 220, 222, 224, 226, 228, and 230 (collectively, the categories 210-230) in FIG. 2. As will be readily appreciated by a quick review of the example informational item 200, the categories 210-230 provide divisions by which foods listed in the product column 202 may be grouped. For example, the category 210 (Deli & Vacuum-Packed Products) includes a sub-entry 210a pertaining to Store-prepared (or homemade) egg, chicken, ham, tuna, macaroni salads. In the refrigerator column 204 pertaining to the sub-entry 210a is an entry indicating that the products listed in the sub-category 210a are viable for three to five days. Further, the freezer column 208 corresponding to the sub-entry 210a indicates that the listed products do not freeze well. Other sub-categories are shown in FIG. 2 as having alpha suffixes on their corresponding category reference number.

Of course, as will be readily appreciated by those having ordinary skill in the art, the products and categories shown in FIG. 2 are merely examples and more or fewer products and/or categories could be listed. Additionally, while the example informational item 200 of FIG. 2 includes both refrigerator and freezer columns 204 and 206, in other examples one of the refrigerator or freezer columns 204, 206 could be eliminated. Additionally, the time durations shown in the refrigerator and freezer columns 204 and 206 may be adjusted to be longer or shorter depending on currently available food research. On that point, the time durations shown in FIG. 2 are for illustrative purposes only and no representation is made as to the accuracy of such time durations. Accordingly, the time durations shown in this patent are not to be used as food storage guidelines. Up-to-date food storage guidelines are readily available from the USDA at their governmental Internet website.

A brief description of the usage of the first example system 100 of FIG. 1 and the example informational item 200 of FIG. 2 is now provided. The first example system 100 of FIG. 1 shows two data entries, one for each of the refrigerator and the freezer. A brief description of the events leading to the entry of the data in the first and second portion 104, 106 will now be provided, along with a description of how users can advantageously rely on the data entered on the first and second portions 104, 106 and data provided on the informational item 114. For example, on Sep. 14, 2002, a user named Dave drove through a fried chicken restaurant on his way home from the office and purchased a 12-piece meal for himself. Dave proceeded to eat four of the pieces and placed the remaining eight pieces in a green Tupperware container. Upon placing the container of fried chicken in the freezer, Dave removed the writing instrument 108 from the housing 102 of the first example system 100. Using the writing instrument 108, Dave completed the date field 130 with the current date (i.e., 9/14/2002) and completed the item and container/owner fields 132, 134 with descriptive information (i.e., that the item is fried chicken and that it is contained in green Tupperware and is owned by Dave). Dave then pulled the informational item 114 (which may be implemented using the example informational item 200 of FIG. 2) from the slot 112 in the housing 102 and determined that fried chicken in the freezer is edible for four months according to the freezer column 206 of the sub-entry 222a (FIG. 2). Although Dave knew that four months from the present day was Jan. 14, 2003, Dave decided to margin on the conservative side and filled in the expiration date field 136 with Dec. 31, 2002 (i.e., 12/31/2002). Having quickly completed the information on the first example system 100, Dave went on his way.

In a similar manner, another member of the home, Joe, ordered pizza on Nov. 2, 2002, and could not finish the whole pie. Joe was particularly fond of cold pizza and, therefore, wrapped the remaining pizza in foil and placed the same in the refrigerator. Using the writing instrument 108, Joe then completed the date, item, and container/owner fields 122, 124, and 126, with indications of the current date (i.e., Nov. 2, 2002), a description of the item (i.e., pizza), and a description of the container and the identity of the owner (i.e., foil—Joe). Then, not knowing how long refrigerated pizza really lasts, Joe examined the informational item 114 (which may be implemented by the example informational item 200 of FIG. 2) and determined that cold pizza is good for three to four days by examining the refrigerator column 204 corresponding to the sub-entry 224a (FIG. 2). Joe then wrote in a date three days from the present date (i.e., Joe wrote in Nov. 5, 2002). Joe then went on his way.

On Nov. 4, 2002, a third roommate, Steve, approached the refrigerator looking for some leftovers. Steve was quickly able to determine, by examining the expiration date fields 126, 136 that Joe's pizza was about to expire the next day. Steve also knew that Joe was gone for the weekend and would not return until Nov. 8, 2002, by which time the pizza would spoil. Steve, also having a particular preference for cold pizza, opened the refrigerator and searched for the foil-wrapped pizza. Upon retrieving the pizza, Steve ate it and erased the entry corresponding to the pizza from the first section 104.

While the foregoing examples were pertinent to food storage and the tracking thereof, informational items may include other types of information. For example, referring to FIG. 2A, an informational item 250 may include a listing of wine types in a first column 252 and information relevant to the wine types in a second column 254. As shown in FIG. 2A, the informational item 250 may include a first section 256 listing wine types and aging suggestions for each of the wine types. For example, as shown Merlot may be stored for 2-5 years. Additionally, the informational item 250 may include a second section 258 listing wine types and the serving and storage temperatures of the various wine types. For example, Chianti is best served at 59° F. and ideally stored at 55° F.

The system 100 of FIG. 1 could be modified to accommodate information associated with the storage of wine. For example, the container/owner field 124 could be eliminated in favor of an early aging date and the expiration date 126 could be eliminated in favor of a late aging date. Such an arrangement would allow a storer of wine to denote windows of time during which each bottle of wine is ideally consumed. Accordingly, rather than the system 100 being mounted on a refrigerator or freezer, it could be mounted on a wine cellar door or could be mounted on the outside or otherwise near a wine refrigerator. Such an arrangement also provides an advantageous manner by which the contents of a wine cellar or storage area may be quickly ascertained.

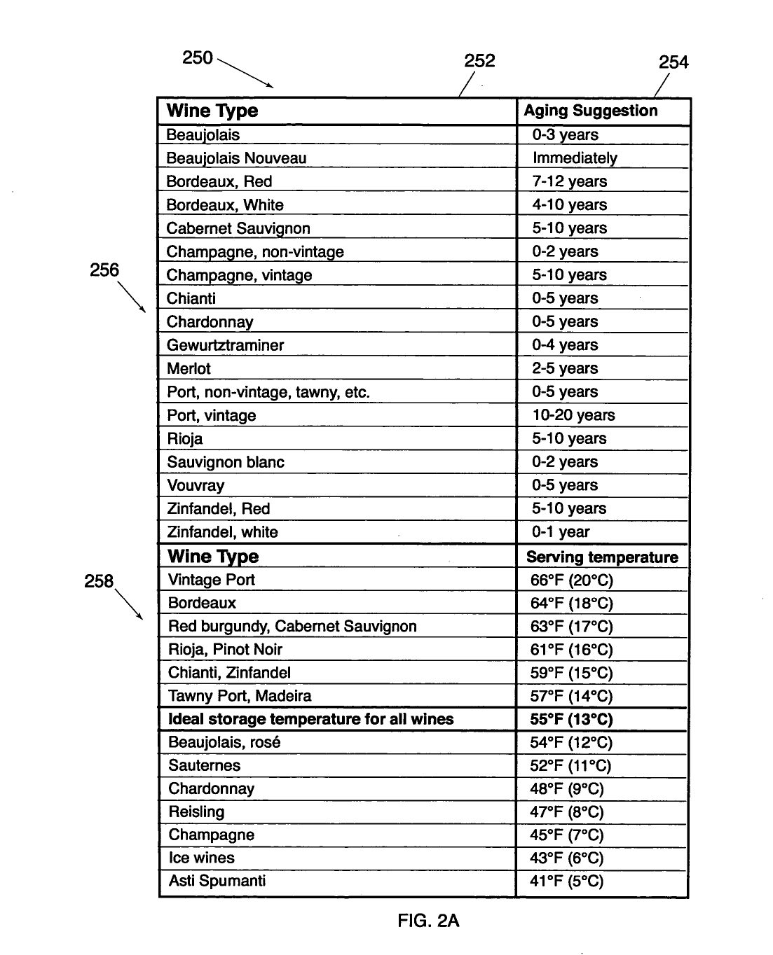

As shown in FIG. 3, which illustrates a rear view of the first example system 100, a number of mounting mechanisms may be provided on the rear of the housing 102. For example, first and second mounting holes 302 and 304 may be provided in the housing 102 to accommodate screws or nails that may be installed into a surface onto which the first example system 100 may be mounted. The mounting holes 302 and 304 may be conventional circular holes or, as shown in FIG. 3, may be circularly shaped holes having adjacent slots at the tops of the circular holes. In such an arrangement, a screw head or a nail head may be inserted into the circular portion of the mounting hole 302 or 304 and the housing 102 may then be slid downwardly so that the shaft of the screw or nail is placed in the adjacent slot.

Additionally or alternatively, the housing may include fastening strips 306, 308 that may be used to fasten the housing 102 to a surface to which the housing 102 is to be mounted. The fastening strips 306 may be implemented using adhesive strips, magnetic strips, Velcro strips, or any other suitable fastening technology. Additionally, the fastening strips 306, 308 need not be fashioned as strips at all and may be formed as squares or circles. Further, although two fastening strips 306, 308 are shown in FIG. 2, more or fewer fastening strips could be used. For example, the housing 102 could include three fastening strips or could include four fastening strips that are disposed in the relative comers of the rear of the housing 102. It is further possible that the housing 102 be adapted for mounting within a refrigerator/freezer door when the refrigerator/freezer is produced in the factory.

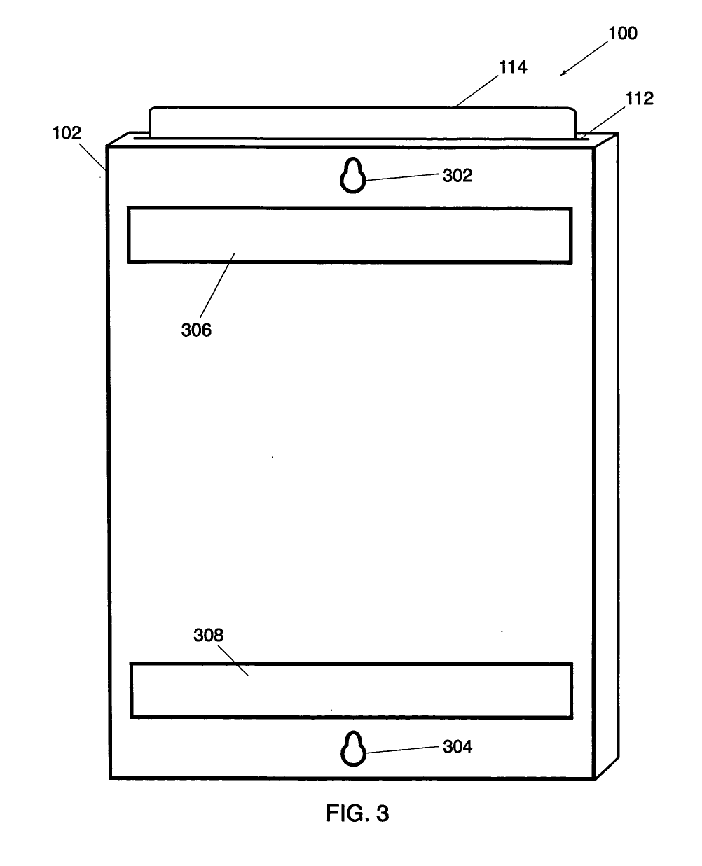

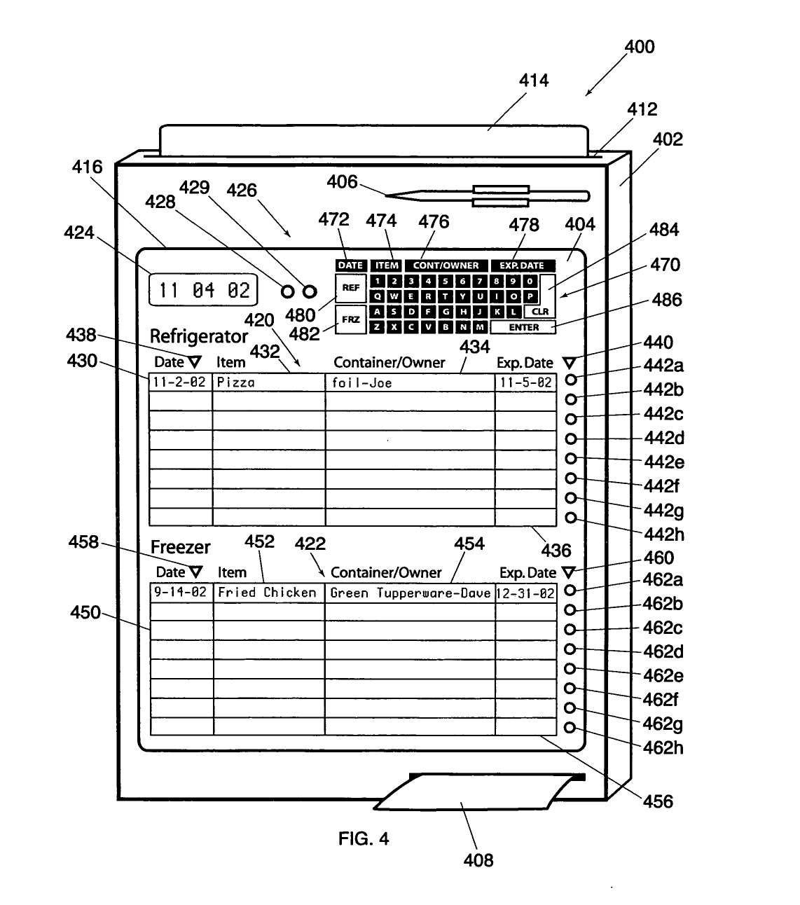

Turning now to FIG. 4, a second example food storage monitoring system 400 (hereinafter “the second example system 400”) is shown. In contrast to the first example system 100, which was primarily mechanical or manual in nature, the second example system 400 is an electronic-based system. In general, as shown in FIG. 4, the second example system 400 includes a housing 402 in which a display 404 is disposed. The display 404 includes various features that are described below. The second example system 400 further includes a stylus 406 that is removeably mounted to the housing 402 and a printer (shown in FIG. 5) capable of printing labels, one of which is shown at reference numeral 408.

The housing 402 may be constructed from any number of different materials such as, for example, plastic, composites, aluminum, or any other suitable material. Like the housing 102 described in conjunction with FIG. 1, the housing 402 includes a slot 412 into which an informational item 414, which may be implemented by the informational item 200 of FIG. 2, may be placed. The housing 404 also includes an aperture 416 through which the display 404 may be viewed.

In general, the display 404 may be implemented using an LCD screen, or any other suitable display device. In particular, as represented in FIG. 4, the display device 404 may be implemented using touch screen technology having a touch-sensitive membrane or coating over an LCD display screen. Such an implementation enables a user to interact with the second example system 400 via the display 404. The display 404 may provide the user with a number of different interactive areas through which information may be displayed to the user and/or through which the user may provide information to the second example system 400. For example, the display 404 may include a refrigerator portion 420 and a freezer portion 422, a temporal display portion 424, and a user input portion 426. Additionally, the display 404 may include user alerts 428 and 429.

The refrigerator portion 420 includes fields corresponding to date 430, item 432, container/owner 434, and expiration date 436. Additionally, the date and expiration date fields 430, 436 further include associated sort icons 438 and 440, respectively. A number of alert indicators 442a-442h are provided in association with each row of the refrigerator portion 420.

Like the refrigerator portion 420, the freezer portion 422 also includes fields corresponding to date 450, item 452, container/owner 454, and expiration date 456. Each of the date and expiration dates 450, 456 includes sort icons 458 and 460, respectively. Alert indicators 462a-462h are provided in correspondence with each row of the freezer portion 422.

The temporal display portion 424 may include the current date, the current date and time, and/or any other suitable representation of temporal information suitable for a user to view when entering information into the second example unit 400. The information represented by the temporal display portion 424 may be purely numerical in nature (e.g., Nov. 4, 2002 is represented by 11/4/2003) or may include alphanumeric information in which the name of a month or an abbreviation of the same are provided.

The user input portion 426 may be implemented as part of the display 404 as shown in FIG. 4 in which graphics on the display 404 are used to represent keys that may be actuated by touching the display screen. Alternatively, the user input portion 426 may be implemented by a separate keypad that is not integrated with the display 404. Further, the user input portion may be implemented using a stylus pad including handwriting recognition functionality. A description of the keys shown on the user input portion 426 is now provided, but it should be noted that the disclosed key configuration is merely one example key configuration and that numerous other permutations of keys could be used.

As shown in FIG. 4, the user input portion 426 may include an arrangement of alpha-numeric keys 470, a date key 472, an item key 474, a container/owner key 476, an expiration date key 478, a refrigerator key 480, a freezer key 482, a clear key 484, and an enter key 486. In operation, a user selects either the refrigerator key 480 or the freezer key 482 followed by the date key 472 and a sequence of alphanumeric keys 470 representing the date value. The user then selects the item key 474 and enters item information before actuating each of the container/owner 476 and expiration date keys 478, each of which is followed by a sequence of alphanumeric keys representing the information corresponding to the selected field. For example, with reference to FIG. 4, when Dave desired to enter his fried chicken into the system 400, Dave actuated the freezer key 482 followed by the date key 472, after which Dave entered the date as “9-14-03.” Dave then actuated the item key 474 and used the alpha keys 470 to enter “Fried chicken.” Following the entry of the date, Dave selected the container/owner key 476, followed by alpha key “green Tupperware—Dave.” Finally, after checking the informational item 413, Dave selected the expiration date key 478 and keyed in “12-31-02” and selected the enter key 486. The system 400 responded to the selection of the enter key 486 by displaying the information shown in FIG. 4. On November 2, Joe repeated a process similar to the enumerated process performed by Dave to enter information pertinent to the pizza in the refrigerator portion 420. When Steve ate the cold pizza, Steve selected the row corresponding to the pizza and selected the clear key 484 to delete the entry corresponding to the pizza.

Upon a user completing the entry of a new food item, the system 400 may prompt the user if he/she desires to print a label (e.g., the label 408) including information entered by the user. For example, after the entry of the pizza item in the refrigerator second 420, Joe may be prompted to print a label with the pizza information thereon so that Joe can stick the label on the pizza, thereby allowing quick identification of the pizza when the examining the contents of the refrigerator. As will be readily appreciated by those having ordinary skill in the art, the information printed on the label can be any subset of information entered by the user. Additionally, different color labels may be used for quick identification of food items. Further, the system 400 may provide a user the ability to print labels for food items that were previously entered. Alternatively, a blank label may be dispensed and information could be hand written thereon.

The alerts 428 and 429 may be implemented using LEDs, which may be, for example, yellow and red in color, respectively. For example, the alert 428 may be a soon to expire alert that is illuminated or flashes when food items listed in the refrigerator or freezer portions 420, 422 are to expire on the following day (i.e., one day past the date shown on the temporal display portion 424). Additionally, the alert 429 may be an expired food item alert that is illuminated or flashes when food items listed in the refrigerator or freezer portions 420, 422 are past their expirations dates (i.e., when the date displayed in the temporal display portion 424 is later than the date listed in the expiration date fields 436 and/or 456). The alerts 428 and 429 may operate in conjunction with an audible alert, which may periodically chirp to alert a user to the fact that food is about to spoil or has already passed its spoiling date. For example, an alert may chirp once an hour when food is about to spoil on the following day and may chirp two times per hour when food has already expired. Further, the alerts 428 and 429 may operate in conjunction with the alert indicators 442a-442h and 462a-462h. For example, the alert indicators 442a-442h and 462a-462h may flash or illuminate yellow in color to alert a user to pending spoilage of the food listed in the row to which the alert indicators 442a-442h and 462a-462h correspond. Additionally, the alert indicators 442a-442h and 462a-462h may flash red in color to alert a user to food spoilage in a particular row.

The sort icons 438, 440, 458, and 460 enable a user to sort the items in the refrigerator portion 420 and the freezer portion 422 according to either the date on which the food was stored (i.e., columns 430 and 450) or on the expiration date of the food items that are stored (i.e., sort according to column 436 and 456). For example, if a user selects the sort icon 438, the food items entered in the refrigerator portion 420 will be sorted according to the date on which they were stored. As a further example, a user who is not fussy can sort the food entries in the refrigerator portion 420 by selecting the sort icon 440, thereby bringing the food items nearest expiration to either the top or the bottom of the food listed in the refrigerator portion 420. In operation, a single selection of a sort icon (e.g., any of the sort icons 438, 440, 458, and 460) may sort food items in ascending chronological order and a second selection of a sort icon may sort the food items in descending chronological order. As will be readily appreciated by those having ordinary skill in the art, more or fewer sort icons than shown in FIG. 4 may be used. For example, sort icons may be provided to enable sorting according to item and/or container/owner information. Accordingly, the number of sort icons shown in FIG. 4 is merely one example of soft icons that may be used to sort by various criteria in the refrigerator and/or freezer portions 420, 422.

As noted above, the systems 100 and 400 disclosed herein may be modified to accommodate the tracking of wine storage. For example, the system 400 of FIG. 4 may have an early aging date field in place of the container/owner field 434. Likewise the expiration date field 436 may be eliminated in favor of a late aging date. Accordingly, users could populate the modified system with information pertinent to their wine collections so that the optimal aging of each wine may be achieved. For example, the combination of the early and late aging dates provides users with windows in which each wine is ideally enjoyed. Additionally, while the alerts 442a-442h are described above as alerting a user when food is about to expire, the alerts 442a-442h may be used to indicate when wines in are in their optimum aging window. For example, if the current date is between an early aging date and a late aging date of a wine, an alert corresponding to that wine may be illuminated as green in color to indicate that the wine is ripe for consumption. Alternatively, the corresponding indicator may be red, yellow, or orange or may flash in various patterns to indicate that a wine has not yet entered the ideal aging window, or has exceeded the ideal aging window.

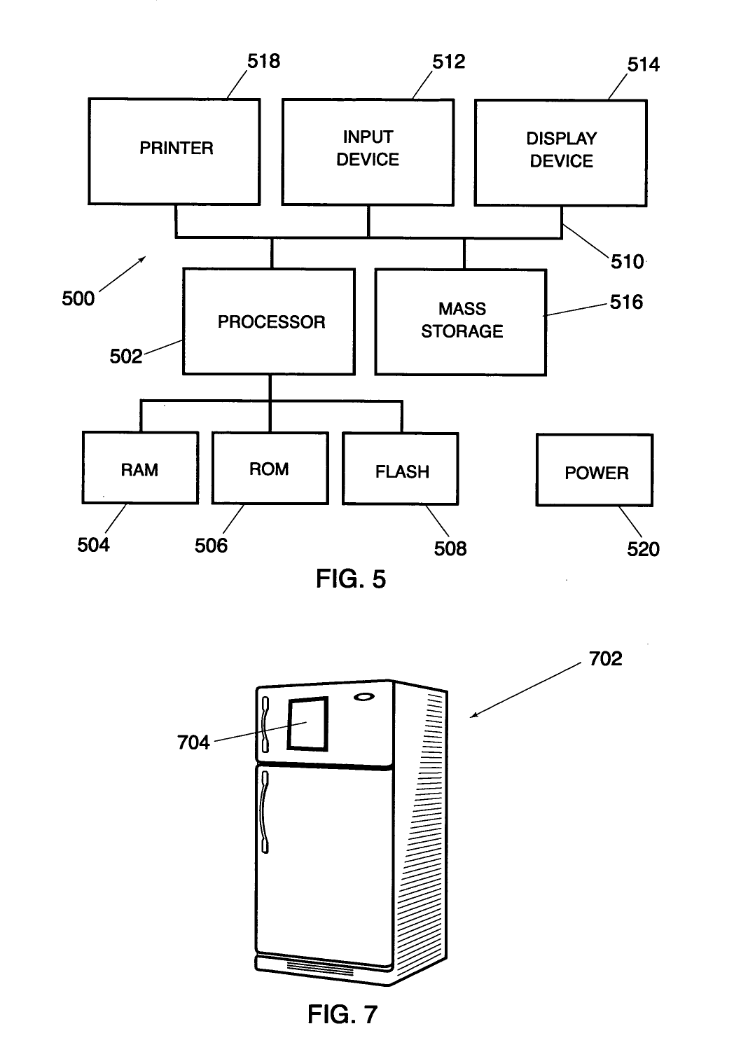

FIG. 5 is a diagram of a hardware system 500 that may be used to implement the system of FIG. 4. In particular, the hardware system 500 may be programmed with instructions used to implement the functionality generally described in conjunction with FIG. 4 and described in detail in conjunction with FIG. 6. As shown in FIG. 5, the hardware system 500 includes a processor 502 having associated memories, such as a random access memory (RAM) 504, a read only memory (ROM) 506, and a flash memory 508. The processor 502 is coupled to an interface, such as a bus 510 to which other components may be interfaced. In the illustrated example, the components interfaced to the bus 510 include an input device 512, a display device 514, a mass storage device 516, and a printer 518. The various components shown in FIG. 5 are powered by a power supply 520.

The processor 502 may be any type of processing unit, such as a microprocessor from the Intel, Advance Micro Devices (AMD), Motorola, or any other supplier of microprocessors. The memories 504, 506, and 508 that are coupled to the processor 502 may be any suitable memory devices and may be sized to fit the storage demands of the system 500. Additionally, one or more of the memories 504, 506, and 508 may be integrated with the processor 502 or may be separate from the processor 502. Additionally, one or more of the memories 504, 506, and 508 may be integrated with one another. Optionally, one of more of the memories 504, 506, and 508 may be eliminated. For example, the flash memory 508 could be eliminated and instructions dictating the operation of the system 500 may be stored in ROM 506 and information (e.g., food item information) provided to the system 500 by the user may be stored in the RAM 504.

Although not shown in FIG. 5, it is contemplated that the hardware system 500 could include a computer interface, which may be, for example, a radio frequency (RF), an infrared (IR), or a cable interconnect to which a computer may be connected. In such an arrangement, the computer could include software that tracks the data provided to the system 400 by the user. The computer interconnection along with Internet connectivity makes it possible to keep a running inventory of items a refrigerator and/or freezer and enables on-line ordering of items when inventory dips below a desired level. Accordingly, the system 400 could be used to track any kind of perishable goods, not just leftovers such as pizza and fried chicken.

As generally discussed in conjunction with FIG. 4, the input device 512 may be implemented using a touch screen. Alternatively, the input device 512 may be implemented using a keypad, a mouse, a track pad, a roller ball, or any other device that enables a user to provide information to the processor 502.

The display device 514 may be, for example, an LCD monitor, a cathode ray tube (CRT) monitor, a plasma display, or any other suitable device that acts as an interface between the processor 502 and a user. As noted previously, the input device 512 may be integrated with the display device 514 to result in a single device that is capable of providing information to a user and is also capable of receiving information from the user.

The mass storage device 516 is an optional component of the system 500 that may be, for example, a conventional hard drive or any other magnetic or optical media that is readable by the processor 502. The presence of the mass storage device 516 in the system 500 enables increased functionality of the system 500 because the data storage capabilities of the system 500 are greatly enhanced by the mass storage device 516. Accordingly, the addition of the mass storage device 516 enables more complex code or software instructions to be stored and implemented by the processor 502 and also provides augmented storage of food item information.

The printer 518 may be implemented using a thermal printer, a laser printer, an ink printer, a dot matrix printer, or any other suitable printer that enables the imparting of information onto labels. The printer 518 may be compact enough to fit within the housing 402 so that labels may be dispensed therethough. Alternatively, the printer 518 may not be directly linked to the processor 502 through the bus 510 and may be linked via some other technique such as RF or IR. In such an arrangement, the printer 518 could be remotely located from the housing 402.

The power supply 520 may be a self-contained unit such as a battery pack or a collection of batteries (e.g., AA batteries, 9-volt batteries, etc.). Such a battery pack could be non-rechargeable (e.g., alkaline batteries) or could be rechargeable in nature (e.g., nickel-metal hydride, nickel-cadmium, lithium-ion, etc.). Alternatively, the power supply 520 could be an external power source such as an alternating current (AC) adapter or any other power cord. The power supply 520 could include power circuitry within or separate from the housing 402. Although for clarity the power supply 520 is not shown as connected to the various components of FIG. 5, those having ordinary skill in the art will readily recognize that the power supply provides operating energy to each of the components of FIG. 5 that require power.

FIG. 6 is a flow diagram representation of an example operating process 600 that may be implemented using one or more sets of software programs, firmware instructions, or other code stored in RAM 504, ROM 506, and/or flash memory 508 and executed by the processor 502. In general, the process 600 controls hardware, such as the hardware of FIG. 5, to monitor the expiration dates of entered food items and to provide a user interface that displays information to a user and receives and processes user input. Although the process 600 is described as instructions carried out by a processor (e.g., the processor 502), it should be noted that some or all of the blocks of the process 600 might be performed manually and/or by other devices. Additionally, although the process 600 is described with reference to the flowchart of FIG. 6, persons of ordinary skill in the art will readily appreciate that many other methods or techniques of performing the process 600 may be used. For example, the order of many of the blocks of FIG. 6 may be altered, the operation of one or more blocks may be changed, blocks may be combined, and/or blocks may be eliminated. Furthermore, while the processes 600 is shown as a single flow diagram, those having ordinary skill in the art will readily recognize that the process 600 could be broken into a number of different diagrams, while still representing the same or equivalent functionality.

The process 600 begins by determining if items listed in the freezer or refrigerator portions (e.g., the portions 420 and 422 of FIG. 4) have expiration dates that are closer than two days to the current date, which may be represented by the temporal display portion 424 (block 602). If a food item is determined to have an expiration date that is within two days of the current date (block 602), an indicator corresponding to the row in which that food item is entered (e.g., one or more of the alert indicators 442a-442h and/or 462a-462h) is flashed (block 604). In addition, other indicators (e.g., the user alerts 428 and 429) may be flashed. After the indicator(s) are flashed, block (604), the rows of the items soon-to-expire may be highlighted (block 606). For example, if an LCD display is used, the rows corresponding to soon-to-expire food items may be shown in a color or shade that contrasts with the balance of the information shown on the display. As will be readily appreciated by those having ordinary skill in the art, the highlighting may be any other technique for drawing the attention of a viewer to soon-to-expire food items. Although the foregoing indicates that a threshold of two days could be selected as a time period for designating soon-to-expire food items, such a time frame is merely one example time frame that could be used. In fact, the soon-to-expire threshold could be a user-programmable feature that could be customized to meet each the desires of each user. Accordingly, the threshold of two days is purely an example.

After the soon-to-expire items are highlighted (block 606) or after it is determined that no items are to expire within, for example, two days (block 602), it is determined if the expiration dates of any items have passed (block 608). If the expiration dates of items have passed (block 608), indicators (e.g., the user alerts 428 and 429) are flashed (block 610). Additionally, an indicator corresponding to the row in which the expired food item is entered (e.g., one or more of the alert indicators 442a-442h and/or 462a-462h) may be flashed. After the indicator(s) are flashed (block 610), the boxes corresponding to the expired food items are highlighted (block 612). As with the indication of soon-to-expire items, rows corresponding to expired items may be shown in contrasting shades or colors.

In general, the color yellow may be used to designate soon-to-expire items and the color red may be used to designate expired items. Accordingly, indicators that are flashed and highlighting that is performed in conjunction with soon-to-expire items may be yellow in color. Further, indicators that are flashed or highlighting that is performed in conjunction with expired items may be red or orange in color. As will be readily appreciated by those having ordinary skill in the art, the selected colors may be other than yellow and red or orange. Additionally, while it is desirable to show contrasting colors between soon-to-expire items and expired items, such a contrast is not essential and the same colors could be used to draw user attention to both soon-to-expire items and expired items.

After it is determined that no food items are past their expiration dates (block 608) or after boxes or rows corresponding to expired food items have been highlighted (block 612), it is determined if the input device has been selected (block 614). The determination that the input device has been selected indicates that a user is attempting to provide information to the system 400. For example, if a user is trying to provide information on new food items or is attempting to change the information associated with one of the food items for which an entry has already been made, the user will use the touch the input device, which, as noted above, may be a touch screen display. Upon detecting that the user has touched the input device (block 614), the input device is read (block 616). Reading the input device may include decoding information entered by the user to determine if information related to new food items has been entered or if existing information pertinent to one or more food items is to be changed. Accordingly, after the input device is read (block 616), the input provided by the user is recognized or decoded (block 618) and the information provided by the user is displayed in an appropriate text box in the display (e.g., the display 404) (block 620).

The user then has an opportunity to approve the displayed text (block 622). If the displayed text is not the information that the user tried to enter, the text is not approved (block 622) and the input device is read again (block 616) so that the user can re-input the desired data. Conversely, if the information is approved (block 622) or if the input device has not been selected (block 614), the process 600 returns to its beginning and determines if there are food items soon to expire (block 602).

As will be readily appreciated by those having ordinary skill in the art, the above-described process 600 includes two main loops of operation. The first loop of operation monitors the expiration date of food items and displays alerts and/or performs highlighting when food items near expiration or have expired. The second loop services information input by the user. However, after the second loop has completed operation, control returns to the first loop, which may continually operate until it is interrupted by a user attempting to input information.

Alternatively, the process 600 of FIG. 6 may be modified to accommodate the tracking of stored wine and, in particular, whether stored wine has entered the ideal aging time. For example, the process 600 may be modified to determine if a current date is between an early aging date and a late aging date of a particular wine. If the current date is between the early and late aging dates, a green indicator (or any other predetermined indicator) may be illuminated to represent that the wine may be optimally consumed. Alternatively, if the current date is before the early aging date or after the late aging date of a wine, red, or yellow indicators may be illuminated or flashed in a particular pattern. Additionally, indicators or patterns of indicator illuminations may be selected to indicate that a particular wine is approaching the ideal aging time or is about to become too old to be ideally enjoyed.

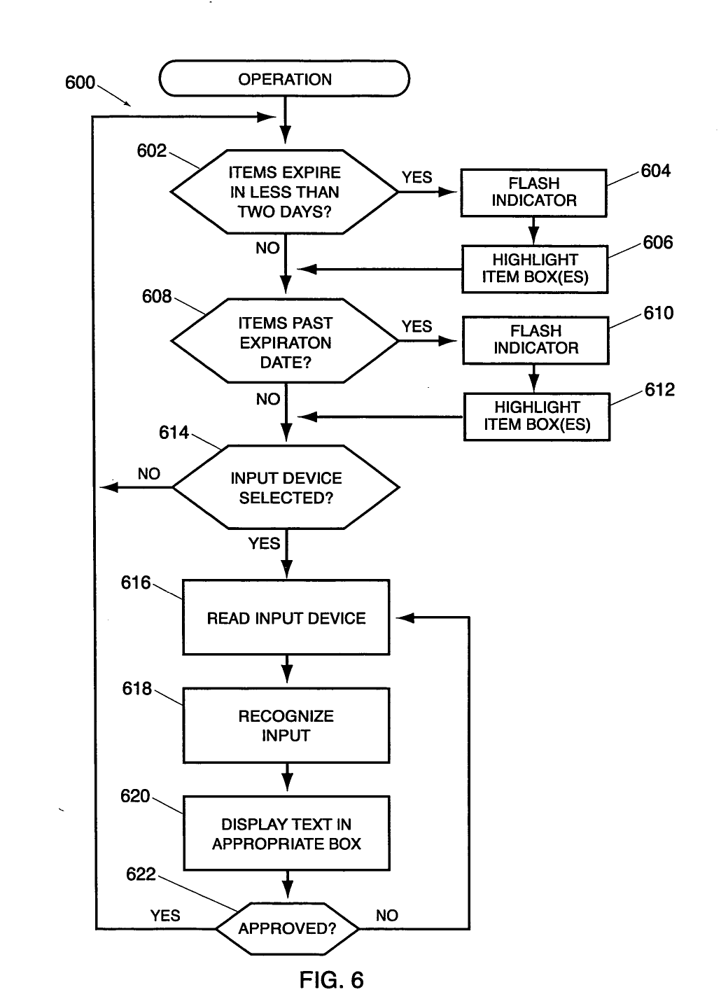

As shown in FIG. 7, a food storage device 702 such as, for example, a refrigerator/freezer may include a food storage monitoring system 704 disposed thereon. The system 704 may be integrated with the food storage device 702 during the manufacturing process of the food storage device 702 and power (if needed) could be provided to the system 704 by the food storage device 702. Alternatively, the system 704 may be an aftermarket system that may be sold directly to consumers who fasten the system 704 to the food storage device 702.

While the food storage device 702 is shown in FIG. 7 as being a refrigerator/freezer having both refrigerator and freezer compartments, those having ordinary skill in the art will readily appreciate that the food storage device 702 could be implemented using a refrigerator having no associated freezer, a dedicated freezer having no associated refrigerator, or simply by a cabinet that is not cooled in any way. For example the system 704 could be used to track the contents of kitchen cabinets. The system 704 could be implemented using either the system 100 of FIG. 1, which is primarily manual in nature, or by the system 400 of FIG. 4, which is electrical/electronic in nature.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. An apparatus to represent the contents of a food storage device, the apparatus comprising:
a housing;
an informational area associated with the housing, wherein the informational area includes a number of fields in which information related to food items in the food storage device may be recorded;
a food storage guideline informational item associated with the housing and representing time durations for which particular food items may be stored without spoiling.

2. An apparatus as defined by claim 1, wherein the fields of the informational area include one or more of a current date field, an item field, a container/owner field, and an expiration date field.

3. An apparatus as defined by claim 2, further comprising a temporal display representing a current calendar date.

4. An apparatus as defined by claim 3, wherein the informational area comprises a material selected from the group consisting of paper, dry erase board, and chalkboard.

5. An apparatus as defined by claim 1, wherein informational area is a first informational area, the apparatus further comprising a second informational area, wherein the first informational area is associated with a first food storage device and wherein the second informational area is associated with a second food storage device.

6. An apparatus as defined by claim 5, wherein the first food storage device comprises a refrigerator and the second food storage device comprises a freezer.

7. An apparatus as defined by claim 1, wherein the housing includes features for mounting the housing to the food storage device and further includes a compartment in which the food storage guideline informational item may be stored.

8. An apparatus to represent the contents of a food storage device, the apparatus comprising:
a housing;
a display screen including an informational area including a number of fields in which information related to food items in the food storage device may be recorded, wherein the information related to food items in the food storage device includes dates on which the food items were stored, descriptions of the food item, and expiration dates of the food items;
a sort icon that may be selected to sort the information in the informational area according to the dates on which food items were stored;
an input section including number of keys for entering information into the informational area;
a food storage guideline informational item associated with the housing and representing time durations for which particular food items may be stored without spoiling.

9. An apparatus as defined by claim 8, further comprising an alert to indicate when a current date is within a predetermined period of time of the expiration dates of food items.

10. An apparatus as defined by claim 9, wherein the predetermined period of time comprises two days.

11. An apparatus as defined by claim 8, further comprising an alert to indicate when a current date is later in time than the expiration dates of food items.

12. An apparatus as defined by claim 8, wherein the informational area is divided into rows, wherein each row corresponds to a food item and wherein each row includes an associated alert, and wherein a first alert associated with a first row listing a first food item and the first alert indicates when a current date is within a predetermined period of time of an expiration of the expiration date of the first food item.

13. An apparatus as defined by claim 8, wherein the informational area is divided into rows, wherein each row corresponds to a food item and wherein each row includes an associated alert, and wherein a first alert associated with a first row listing a first food item and the first alert indicates when a current date is later in time than the expiration date of the first food item.

14. An apparatus as defined by claim 8, wherein the informational area is a first informational area that is associated with a refrigerator food storage device, the display screen further including a second informational area that is associated with a freezer food storage device.

15. An apparatus as defined by claim 8, further comprising a printer configured to print information onto labels to be placed on food items.

16. An article of manufacture comprising a machine-accessible medium having a plurality of machine accessible instructions that, when executed, cause a machine to:
receive from a user information related to a food item, wherein the information related to the food item includes an expiration date of the food item;
display the information related to the food item;
compare a current date to the expiration date of the food item;
indicate if the current date is a specified number of days prior to the expiration date of the food item; and
indicate if the current date is later in time than the expiration date of the food item.

17. A food storage device comprising:
a compartment for storing food items; and
an apparatus to represent the contents of a food storage device, the apparatus comprising:
a housing;
a display screen including an informational area including a number of fields in which information related to food items in the food storage device may be recorded, wherein the information related to food items in the food storage device includes dates on which the food items were stored, descriptions of the food item, and expiration dates of the food items;
a sort icon that may be selected to sort the information in the informational area according to the dates on which food items were stored;
an input section including number of keys for entering information into the informational area;
a food storage guideline informational item associated with the housing and representing time durations for which particular food items may be stored without spoiling.

18. A food storage device as defined by claim 17, wherein the compartment comprises a freezer.

19. A food storage device as defined by claim 17, wherein the compartment comprises a refrigerator.
